(19) United States
(12) Patent Application Publication
(10) Pub. No.: US 2020/0117733 A1
(43) Pub. Date: Apr. 16, 2020

(54) BLOCKCHAIN INTEGRATION LAYER

(71) Applicant: SAP SE, Walldorf (DE)

(72) Inventors: Kai-Christoph Mueller, Cupertino, CA (US); Frank Renkes, Graben-Neudorf (DE); Brian McKellar, Heidelberg (DE)

(21) Appl. No.: 16/157,866

(22) Filed: Oct. 11, 2018

(51) Int. Cl. G06F 17/30; H04L 9/06

(52) U.S. Cl. CPC G06F 17/30377; H04L 2209/38; G06F 17/30339; H04L 9/0637

(57) ABSTRACT

A blockchain integration layer uses mappings, for each blockchain of a plurality of blockchains, to integrate blockchain data into a database. A user interface may be presented that allows a user to view the blockchain data from the database, create data for the blockchain in the database, or both. Based on the created data for the blockchain in the database, the blockchain integration layer may modify the blockchain to store the created data. Standardized mappings are used to define the transformations to be used to convert data stored in blockchain blocks into a usable format for external systems. A set of JavaScript object notation (JSON) objects, one for each supported message type, may be used to define the set of transformations to support a blockchain. Using multiple sets of JSON objects, the blockchain integration layer integrates multiple blockchains with the external systems.

### TECHNICAL FIELD

The subject matter disclosed herein generally relates to methods and systems for system integration. Specifically, the present disclosure addresses systems and methods to enable interchange between blockchain blocks and external systems via standardized mappings in an integration layer.

### BACKGROUND

Existing systems for display of data stored in blockchain blocks are specific to the particular blockchain storing the data. Thus, a system for display of Bitcoin data is separate from a system for the display of Ethereum data. Likewise, existing systems for storage of data into blockchain blocks are specific to the particular blockchain that will store the data.

### BRIEF DESCRIPTION OF THE DRAWINGS

Some embodiments are illustrated by way of example and not limitation in the figures of the accompanying drawings.

FIG. 1 is a network diagram illustrating a network environment suitable for implementing a blockchain integration layer, according to some example embodiments.

FIG. 2 is a block diagram of a database server, according to some example embodiments, suitable for implementing a blockchain integration layer.

FIGS. 3-5 are block diagrams illustrating a database schema suitable for implementing a blockchain integration layer, according to some example embodiments.

FIG. 6 is a flowchart illustrating operations of a method suitable for accessing data using a blockchain layer, according to some example embodiments.

FIG. 7 is a flowchart illustrating operations of a method suitable for storing data in a blockchain using a blockchain integration layer, according to some example embodiments.

FIG. 8 is a flowchart illustrating operations of a method suitable for accessing data in multiple blockchains using a blockchain integration layer, according to some example embodiments.

FIG. 9 is a user interface diagram of a user interface suitable for presenting data in multiple blockchains using a blockchain integration layer, according to some example embodiments.

FIG. 10 is a user interface diagram of a user interface suitable for creating a blockchain service key for use by a blockchain integration layer, according to some example embodiments.

FIG. 11 is a user interface diagram of a user interface suitable for creating a blockchain service key for use by a blockchain integration layer, according to some example embodiments.

FIG. 12 is a user interface diagram of a user interface suitable for controlling blockchain integration by a blockchain integration layer, according to some example embodiments.

FIG. 13 is a block diagram illustrating components of a machine, according to some example embodiments.

### DETAILED DESCRIPTION

Example methods and systems are directed to the generation and use of a blockchain integration layer. A blockchain integration layer uses mappings, one for each blockchain, to integrate blockchain data into a database. A user interface may be presented that allows a user to view the blockchain data from the database, create data for the blockchain in the database, or both. Based on the created data for the blockchain in the database, the blockchain integration layer may modify the blockchain to store the created data example, the created data may be written onto the blockchain.

Blockchain technology is based on interlinked blocks. Each block contains data for one or more transactions. The data in the blocks can be read using blockchain-specific tools, but there is no general approach to exchanging data between blockchains and external systems (e.g., persistent storage, analytic tools, streaming engines, or machine learning systems). Different blockchains have different formats for the blocks in the blockchain. Example blockchains include Hyperledger Fabric, Ethereum, Bitcoin, and MultiChain.

As described herein, standardized mappings may be used to define the transformations to be used to convert data stored in blockchain blocks (e.g., transactions) into a usable format for external systems. For example, one standardized JavaScript object notation (JSON) object may be used to define a transformation for one message type of one blockchain. A particular message type is a particular type of transaction (e.g., “Order Supplies” or “Pay Supplier”). A set of JSON objects, one for each supported message type, may be used to define the set of transformations to support the different transactions used in a blockchain. Using multiple sets of JSON objects, the blockchain integration layer integrates multiple blockchains with the external systems.

In some example embodiments, an external system requests information from the blockchain integration layer for a specific message type for a specific blockchain. The blockchain integration layer retrieves the information from the blockchain, transforms the information into a JSON message, and returns the JSON message to the external system. The external system maps the JSON data to its own schema for further use. For example, the JSON data may be mapped to a database schema and stored in a database (e.g., a high-performance analytic appliance (HANA) database)

When these effects are considered in aggregate, one or more of the methodologies described herein may obviate a need for certain efforts or resources that otherwise would be involved in accessing or creating blockchain data. Computing resources used by one or more machines, databases, or networks may similarly be reduced. Examples of such computing resources include processor cycles, network traffic, memory usage, data storage capacity, power consumption, and cooling capacity.

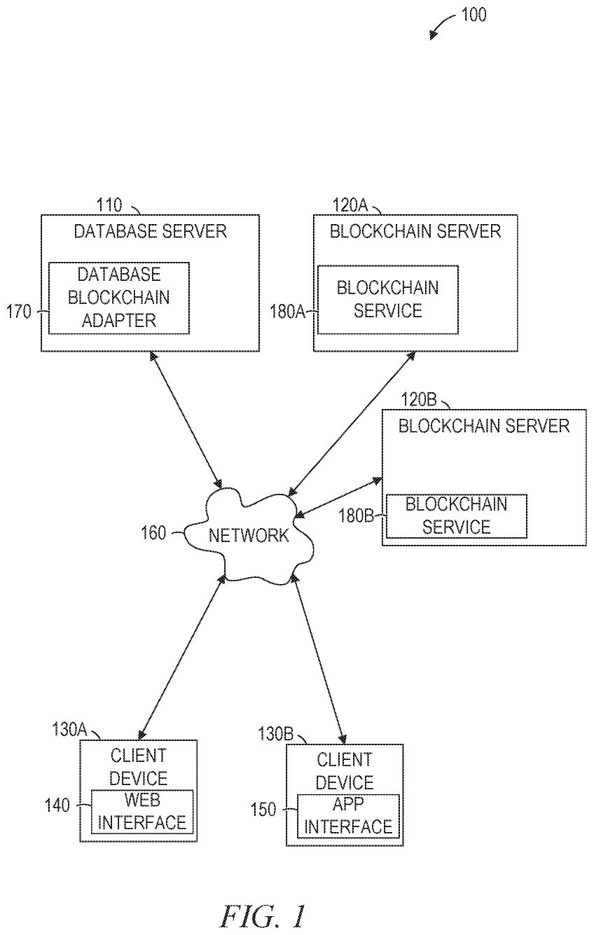

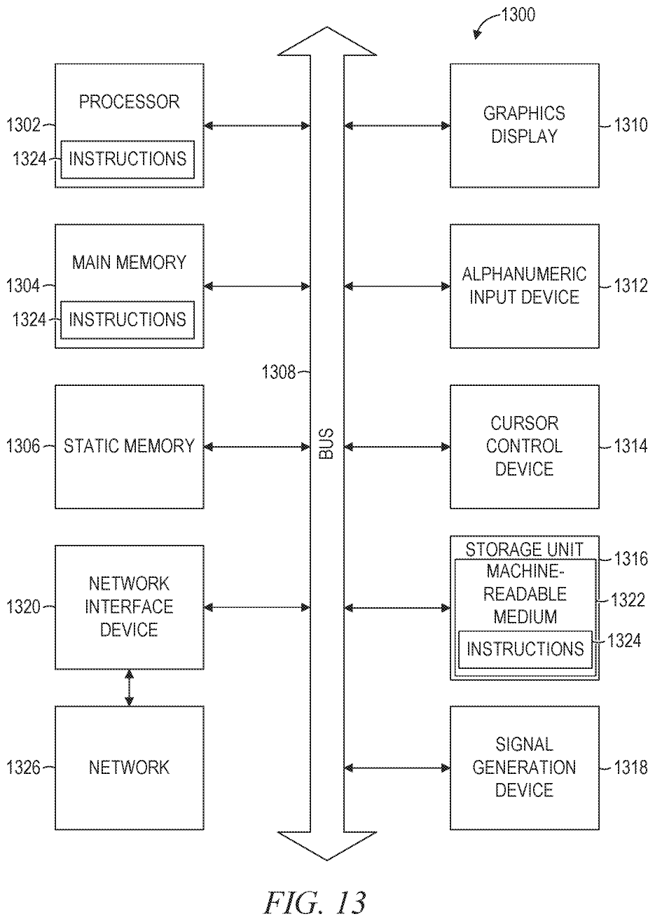

FIG. 1 is a network diagram illustrating a network environment 100 suitable for implementing a blockchain integration layer, according to some example embodiments. The network environment 100 includes a database server 110 including a database blockchain adapter 170, a blockchain server 120A including a blockchain service 180A, a blockchain server 120B including a blockchain service 180B, client devices 130A and 130B, and a network 160. The database server 110 provides database access to the client devices 130A and 130B via a web interface 140 or an application interface 150. The database server 110, the blockchain servers 120A and 120B, and the client devices 1301 and 130B may each be implemented in a computer system, in whole or in part, as described with respect to FIG. 13. The client devices 130A and 130B may be referred to collectively as client devices 130 or generically as a client device 130. The blockchain servers 1201 and 120B may be referred to collectively as blockchain servers 120 or generically as a blockchain server 120. The blockchain services 180A and 180B may be referred to collectively as blockchain services 180 or generically as a blockchain service 180.

In some example embodiments, each blockchain server 120 participates in a peer-to-peer topology including other blockchain servers connected via the network 160. Each participating server in a blockchain is referred to as a “node” of the blockchain. The blockchain is a distributed ledger that stores all transactions of the blockchain. A consensus protocol of the blockchain is used to validate transactions. In some example embodiments, a majority of the nodes must agree that the transaction is valid. Each blockchain server 120 provides information about the blockchain to other devices via the corresponding blockchain service 180. For example, the blockchain service 180A may support an application programming interface (API) or a representational state transfer (REST) interface that allows the database server 110 and the client devices 130A and 130B to request data from blocks in the blockchain, to request data for transactions that have been added to the blockchain, to provide data for new transactions to be added to the blockchain, or any suitable combination thereof.

The database server 110 may receive a search query from a client device 130 and provide results from a database. The database blockchain adapter 170 is configured to translate data received from the blockchain service 180 to a format used by the database. As a result, subsequent queries for blockchain data from the client devices 130 can be satisfied using data from the database. Typically, accessing data from a database is faster for the database server 110 than accessing data from the blockchain service 180. As a result, the responsiveness of a service provided to the client devices 130A and 130B is improved. The database blockchain adapter 170 is also configured to transfer data from a format used by the database to a format used by the blockchain service 180 to create new transactions on the blockchain. As a result, the client devices 130 are enabled to use a database interface provided by the database server 110 to create database records that are later converted to blockchain transactions using the database blockchain adapter 170. Typically, creating an entry in a blockchain would require the user to directly interface with the blockchain service 180, requiring additional effort (e.g., installation of additional software) by the user. By contrast, a client device 130 that already interfaces with the database server 110 does not require modification to make use of the database blockchain adapter 170 to interface with the blockchain service 180,

Some blockchain types support smart contracts, also referred to as chaincode. A smart contract is a program that can be invoked to update or query the blockchain. In some example embodiments, a blockchain integration layer is supported by adding extensions to the chaincode of the blockchain being integrated. Different blockchains use different technologies to implement smart contracts. For example, Hyperledger Fabric uses chaincode and Ethereum uses Solidity. The specific examples below are made with reference to chaincode, which should be taken as an example rather than a limitation.

For example, in a Hyperledger Fabric, chaincode may provide any number of functions, with both the syntax (naming and parameters) and semantics (effect) of the functions determined by the programmer. An additional method may be added that has known syntax and interfaces with the arbitrary functions provided by the chaincode. Thus, in an example Hyperledger Fabric blockchain that has chaincode with read, create, update, and delete functions accessible via the invoke function, an additional $SQL method is added that supports the commands schema, select, insert, update, and delete. The select, insert, update, and delete commands route to the read, create, update, and delete functions respectively. The schema command provides message type mappings in JSON format.

The example code below extends the invoke function to add support for a $SQL command:

func (cc *HelloWorld) Invoke(stub shim.ChaincodeStubInterface) peer.Response {

function, args := stub.GetFunctionAndParameters( )
switch function {
case “read”:

return cc.read(stub, args)

case “create”:

return cc.create(stub, args)

case “update”:

return cc.update(stub, args)

case “delete”:

return cc.delete(stub, args)

case “$SQL”:

return cc.SQL(stub, args)

}

The example code below adds the $SQL function called by the Invoke function above. The specific code of the $SQL function is specific to this chaincode example.

func (cc *HelloWorld) SQL(stub shim.ChaincodeStubInterface, args

[ ]string) peer.Response {

cmd := strings.ToUpper(args[0])
switch cmd {
case “SCHEMA”:

return Success(http.StatusOK, “Message Schema”, [ ]byte(schema))

case “SELECT”:

return cc.read(stub, [ ]string{args[1]})

case “INSERT”:

var doc Doc
return cc.create(stub, [ ]string{args[1],
doc.FromJson([ ]byte(args[3])).Text})

case “UPDATE”:

var doc Doc
return cc.update(stub, [ ]string{args[1],
doc.FromJson([ ]byte(args[3])).Text})

case “DELETE”:
return cc.delete(stub, [ ]string{args[1]})
}
return Error(http.StatusNotImplemented, “Invalid $SQL! Valid methods are
‘SCHEMA|SELECT|INSERT|UPDATE|DELETE’!”)

}

In some example embodiments, to create a remote source that accesses a blockchain service, an administrator provides one or more of: a uniform resource locator (URL) to the blockchain service, an access token URL to authenticate a user account for using the blockchain service, and credentials of the user account. The access token URL and the credentials may be provided by the SAP Cloud Platform Blockchain Application Enablement service. The credentials may include a client identifier and a client secret (e.g., a client password). Additionally, properties may be provided for a proxy that is used to access the blockchain service, the authentication service, or both. The proxy properties may include a proxy host, a proxy port number. In some example embodiments, the properties include a polling interval that indicates how often polling operations are run to retrieve new data from the blockchain. Example code for creating a remote source within the connecting database server is below.

CREATE REMOTE SOURCE ″BlockchainExatnple″

ADAPTER ″BlockchainAdapter″
AT LOCATION AGENT ″BC_AGENT″

CONFIGURATION

‘<?xml version=″1.0″ encoding=″UTF-8″?>
<ConnectionProperties name=″Connection″>

<PropertyEntry name=″url″>

https://my_server_name.com/blockchain/hanaIntegration/api/v1</PropertyEntry>

<PropertyEntry name=″accessTokenURL″>

https://my_authenticationserver_name.com/oauth</PropertyEntry>

<PropertyEntry name=″pollingInterval″>5</PropertyEntry>
<PropertyEntry name=″proxyHostName″>

proxy</PropertyEntry>

<PropertyEntry name=″proxyPortNumber″>

8080</PropertyEntry>

</ConnectionProperties>

WITH CREDENTIAL TYPE ‘PASSWORD’ USING
‘<CredentialEntry name=″credential″>
<user>client id</user>
<password>client secret</password>
</CredentialEntry>’

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed with respect to FIG. 13. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The database server 110, the blockchain servers 120A-120B, and the client devices 130A-130B may be connected by the network 160. The network 160 may be any network that enables communication between or among machines, databases, and devices. Accordingly, the network 160 may be a wired network, a wireless network (e.g., a mobile or cellular network), or any suitable combination thereof. The network 160 may include one or more portions that constitute a private network, a public network (e.g., the Internet), or any suitable combination thereof.

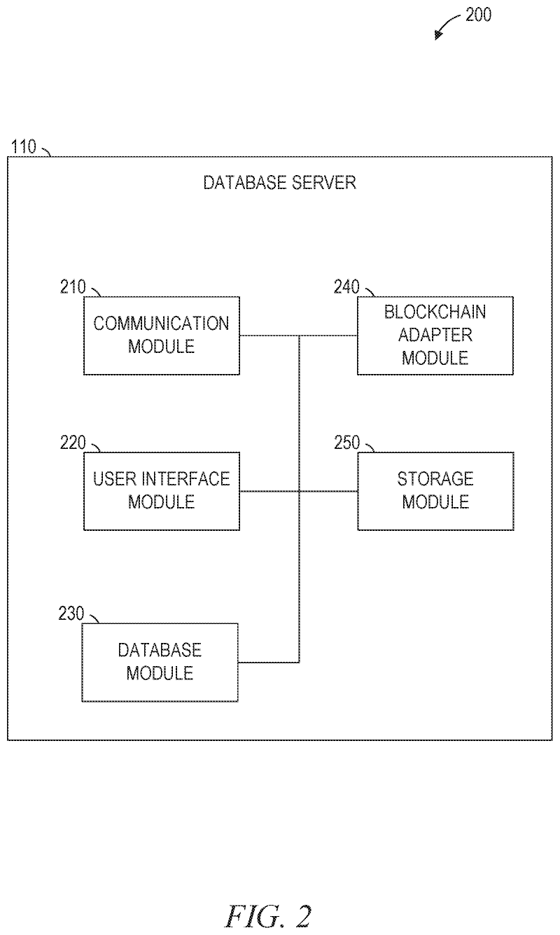

FIG. 2 is a block diagram 200 illustrating components of the database server 110, according to some example embodiments. The database server 110 is shown as including a communication module 210, a user interface module 220, a database module 230, a blockchain adapter module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the database server 110 and transmits data from the database server 110. For example, the communication module 210 may receive, from the client device 130A, a query comprising a text string. The communication module 210 provides the query to the database module 230. The database module 230 searches a database via the storage module 250 to identify records responsive to the query. The communication module 210 may transmit the responsive data to the client device 130A. Communications sent and received by the communication module 210 may be intermediated by the network 160.

The user interface module 220 causes presentation of a user interface for the database server 110 on a display associated with the client device 130A or 130B. The user interface allows a user to view data stored in the database, to modify data stored in the database, to add data to the database, or any suitable combination thereof.

The blockchain adapter module 240 implements the features of the database blockchain adapter 170, described above with respect to FIG. 1. Accordingly, the blockchain adapter module 240 translates data received from the blockchain services 180 to a format used by the database and transfers data from the format used by the database to a format used by the blockchain service 180 to create new transactions on the blockchain. The blockchain adapter module 240 acts as an intermediary for multiple blockchain servers 120A-120B by using a different mapping for each blockchain.

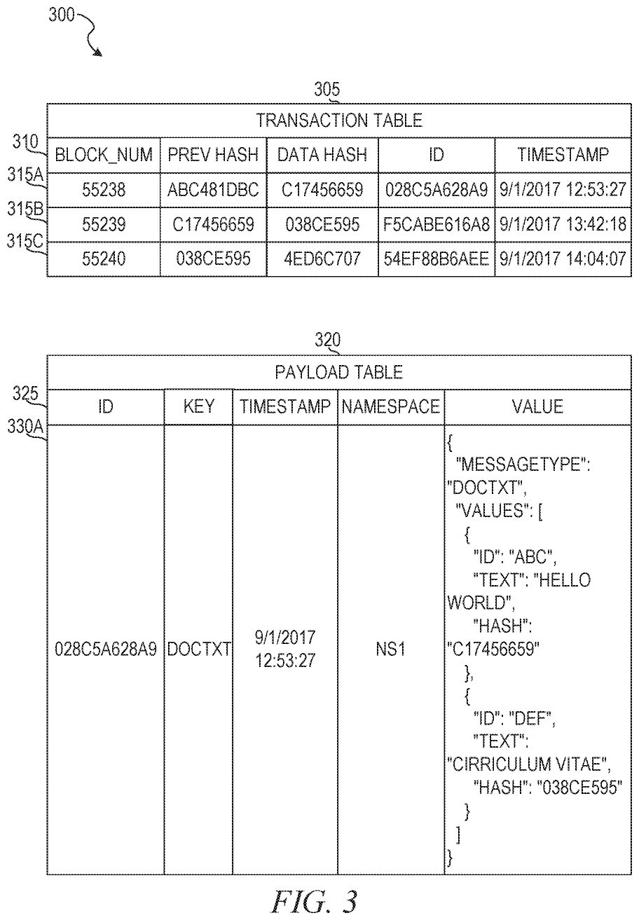

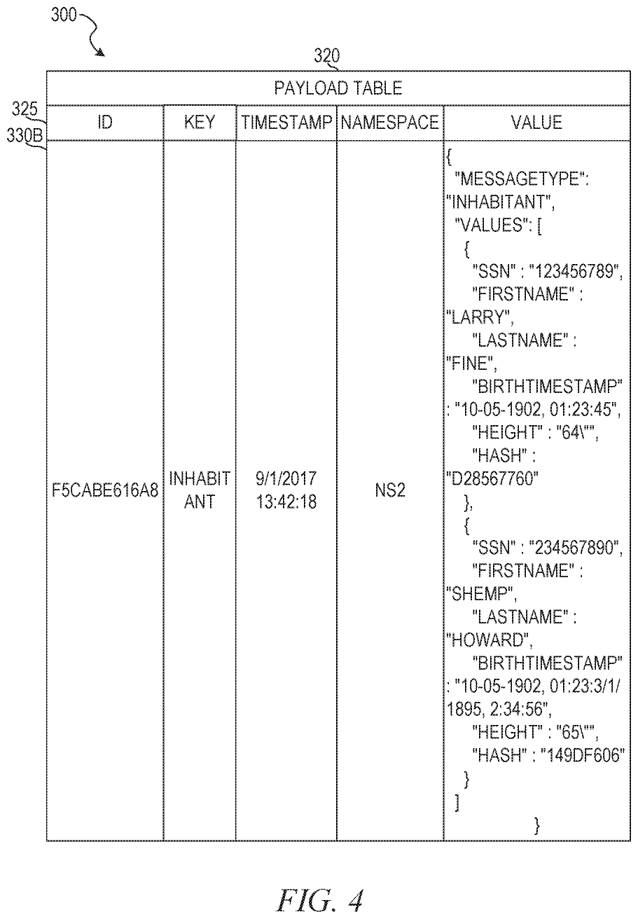

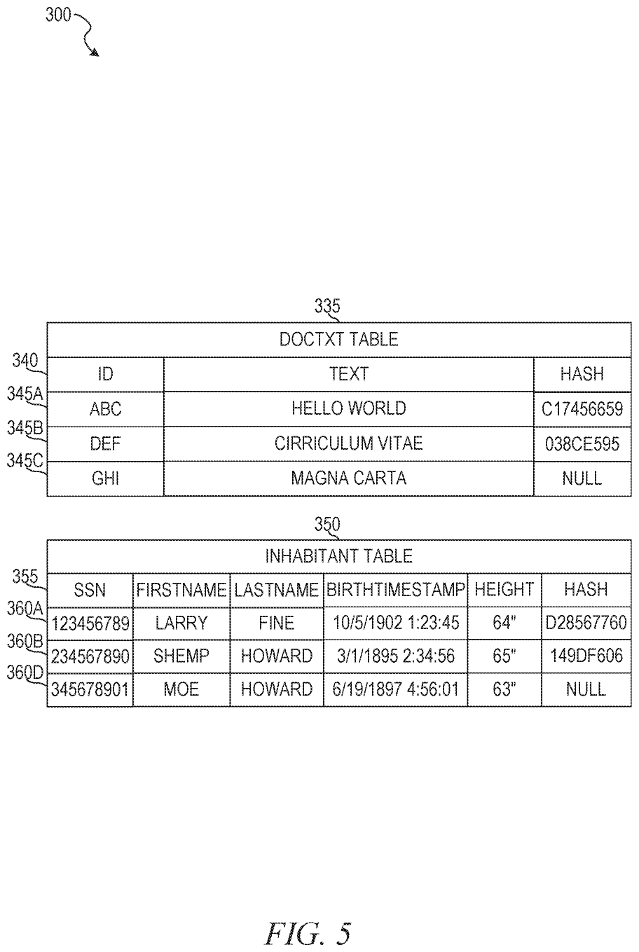

FIGS. 3-5 are block diagrams illustrating a database schema 300 suitable for implementing a blockchain integration layer, according to some example embodiments. The database schema 300 provides tables to store data in generic predefined formats that apply to many types of blockchain transactions as well of specific data that applies to particular message types. The database schema 300 includes a transaction table 305 (FIG. 3), a payload table 320 (FIGS. 3-4), a docTxt table 335 (FIG. 5), and an inhabitant table 350 (FIG. 5). The transaction table 305 has rows 315A, 31513, and 315C of a format 310. Each row of the transaction table 305 stores data for a transaction of a blockchain. The payload table 320 has row 330A (FIG. 3) and row 330B (FIG. 4) of a format 325. Each row of the payload table 320 stores data for a key-value pair associated with a transaction. The docTxt table 335 has rows 345A, 345B, and 345C of a format 340. Each row of the docTxt table 335 stores data for a message of type docTxt. The inhabitant table 350 has rows 360A, 360B, and 360C of a format 355. Each row of the inhabitant table 350 stores data for a message of type inhabitant. Tables of the database schema 300 may be stored in one database or multiple databases.

The format 310 of the transaction table 305 includes a block number field, a previous hash field, a data hash field, an identifier field, and a timestamp field. The block number field stores the block of the blockchain in which the transaction is stored, referred to as the current block. The previous hash field stores the hash of the preceding block in the blockchain. The data hash field stores the hash of the current block. The identifier field stores a unique identifier for the transaction. Rows in the payload table 320 using an identifier are associated with the row in the transaction table 305 having the same identifier. The timestamp field stores a timestamp associated with the current block (e.g., the date and time at which the block was committed to the blockchain).

The format 325 of the payload table 320 includes an identifier field, a key field, a timestamp field, a namespace field, and a value field. The identifier field relates a row in the payload table 320 to a row in the transaction table 305. The timestamp field stores a timestamp associated with the key-value pair. In sonic example embodiments, the timestamp field in a row of the payload table 320 stores the same value as the timestamp field in the corresponding row of the transaction table 305.

The namespace field distinguishes between multiple uses of the same message type identifier by different smart contracts. For example, there may be multiple smart contracts being deployed in different scenarios, all using the same message type, with possibly the same message identifier. In this case, a reuse of that particular mapping is possible and encouraged with the namespace differentiating between the different smart contracts. Thus, a unique identifier for the value may be formed by prepending the to the key with a connecting character that is not permitted in either the namespace or the key. As an example, if the tilde character is used as the connecting character, the string “NS1˜DOCTXT” is an identifier for the value of row 330A, allowing another namespace to also use the “DOCTXT” key without possibility of collision. The value field of the row 330A contains data for a single docTxt message in JSON format. The value field of the row 330B contains data for a single inhabitant message in JSON format.

The format 340 of the docTxt table 335 includes an identifier field, a text field, and a hash field. The identifier field stores an identifier for the message. The text field stores the message text. The hash field stores the hash of the block storing the data or NULL if the data is not stored in the blockchain. Data in the docTxt table 335 may be populated by a blockchain integration layer based on data read from a blockchain and a mapping. For example, the mapping code below may be used to indicate that messages of type docTxt should be stored in a table with an ID column and a text column, wherein the ID column is of type string with length 1-16 characters and is a search key for the table, and the text column is of type string with length 0-255 characters. Note that the JSON code below defines the mapping to be used by the blockchain adapter module 240 to create docTxt entries, but the JSON element in row 330B contains the data for a particular docTxt entry created by the blockchain adapter module 240.

{

“messages”: [

{

“type”: “docTxt”,
“properties”: [
{

“ID”: {

“isKey”: true,
“description”: “ID of the message”,
“type”: “string”,
“maxLength”: 16,
“minLength”: 1

}

},
{

“text”: {

“description”: “The message text.”,
“type”: “string”,
“maxLength”: 255

}

}
]

}

]

}

When data is imported from a blockchain to a database table or exported from a database table to a blockchain, the type of the data may be changed during the import or export. For example, blockchain types of string and float may be converted to and from database types of NVCHAR and DOUBLE, respectively. Other data types may not be converted. For example, blockchain types of integer, timestamp and Boolean may directly map to database types of INTEGER, TIMESTAMP, and BOOLEAN.

The format 355 of the inhabitant table 350 includes a social security number (“SSN”) field, a firstName field, a lastName field, a birthTimestamp field, a height field, and a hash field. The SSN field stores a social security number for the inhabitant. The firstName and lastName fields collectively store the name of the inhabitant. The birthTimestamp field stores a date and time of birth for the inhabitant. The height field stores a height of the inhabitant. The hash field stores the hash of the block storing the data or NULL if the data is not stored in the blockchain. Data in the inhabitant table 350 may be populated by a blockchain integration layer based on data read from a blockchain and a mapping. The blockchain corresponding to the inhabitant table 350 may be the same as or different from the blockchain corresponding to the docTxt table 335. For example, the docTxt messages associated with the rows 345A-345C of the docTxt table 335 may be stored in a first blockchain (e.g., a HyperLedger Fabric) of the blockchain server 120A and the inhabitant messages associated with the rows 360A-360C of the inhabitant table 350 may be stored in a second blockchain (e.g., a MultiChain) of the blockchain server 120B. The mapping code below may be used to indicate that messages of type inhabitant should be stored in a table with an SSN column, a firstName column, a lastName column, a birthTimestamp column, and a height column, wherein the SSN column is of type string with length 1-16 characters and is a search key for the table, the firstName and lastName columns are each strings with length 1-64 characters, the birthTimestamp column is of the type timestamp, and the height column is of type float. Note that the JSON code below defines the mapping to be used by the blockchain adapter module 240 to create inhabitant entries, but the JSON element in row 330B contains the data for a particular inhabitant entry created by the blockchain adapter module 240.

{

“messages”: [

{

“type”: “inhabitant”,
“properties”: [

{

“SSN”: {

“isKey”: true,
“type”: “string”,
“description”: “The social security number of an inhabitant”,
“minLength”: 1,
“maxLength”: 16

}

},
{

“firstName”: {

“description”: “The first name of the inhabitant”,
“type”: “string”,
“minLength”: 1,
“maxLength”: 64

}

},
{

“lastName”: {

“description”: “The last name of the inhabitant”,
“type”: “string”,
“minLength”: 1,
“maxLength”: 64

}

},
{

“birthTimestamp”: {

“description”: “Date and time of birth of the inhabitant”,
“type”: “timestamp”

}

},
{

“height”: {

“description”: “Body height of the inhabitant in meter”,
“type”: “float”

}

}

]

}

]

}

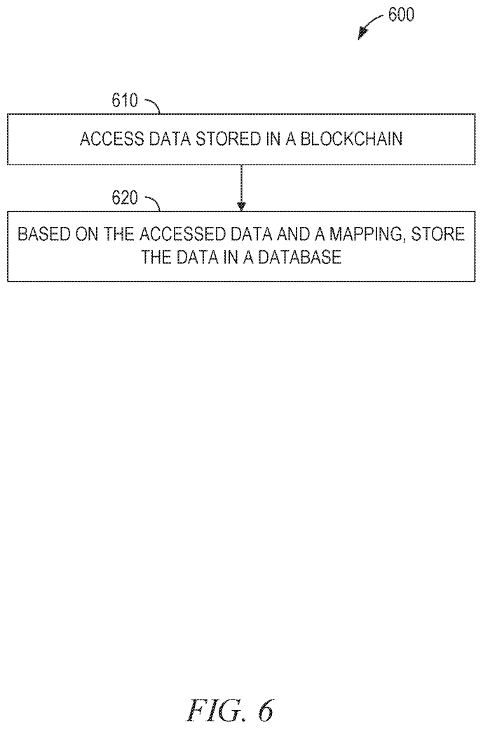

FIG. 6 is a flowchart illustrating operations of a method 600 suitable for accessing data using a blockchain integration layer, according to some example embodiments. The method 600 includes operations 610 and 620. By way of example and not limitation, the method 600 is described as being performed by the devices, modules, and databases of FIGS. 1-3.

The blockchain adapter module 240 accesses, in operation 610, data stored in a blockchain. The blockchain adapter module 240 may access the data.

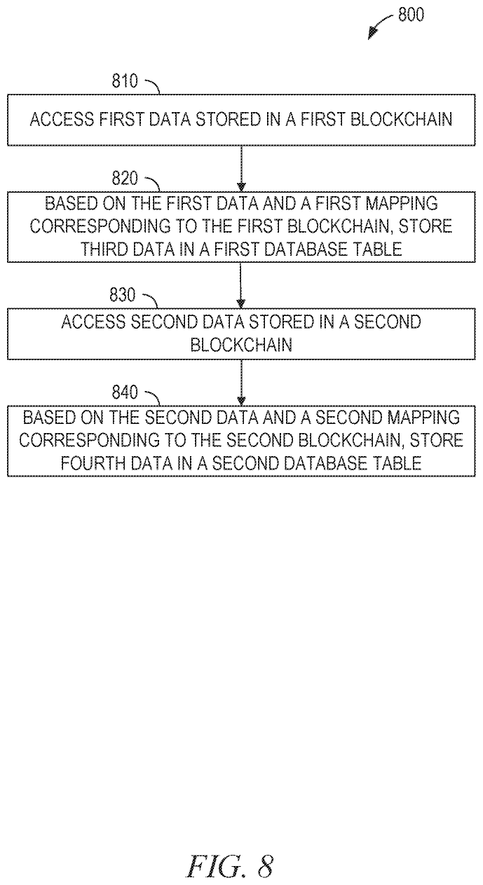

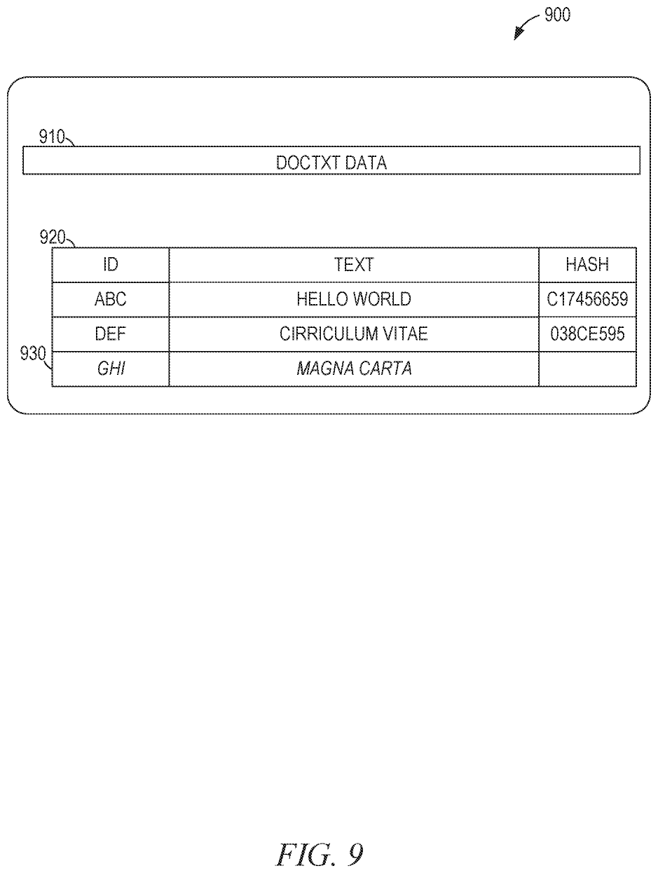

directly from blockchain blocks (e.g., blk*.dat files used to store Bitcoin blocks), from an intermediate database (e.g., a LevelDB database in a Hyperledger Fabric storing index data or chain state data), or any suitable combination thereof (e.g., using the intermediate database to identify a block and accessing data from a block file containing data for the identified block). Configuration data for accessing the blockchain may be defined using the user interface 800 or the user interface 900, described below with respect to FIGS. 8-9.

In some example embodiments, the database server 110 is a node on the blockchain network that maintains a current copy of the blocks in the blockchain. In these embodiments, the blockchain adapter module 240 accesses the data from local files. In other example embodiments, the database server 110 accesses the blockchain data via the network 160 from a blockchain server 120, for example by remotely executing an Invoke function in a smart contract. The accessed data may be received in the form of a JSON data structure comprising key-value pairs.

In operation 620, the blockchain adapter module 240 uses the accessed data and a mapping to store the data in a database. For example, the mapping may map keys stored in the JSON data structure to columns in a table in the database. Thus, a row may be created in the table for the JSON data structure, with the value of each key-value pair stored in the column corresponding to the key of the key-value pairs. Key-value pairs with keys not indicated in the mapping may be discarded or stored in a default column. For example, a message of type “docTxt” may be mapped to the docTxt table 335, with each row storing values for the keys “ID,” and “text.”

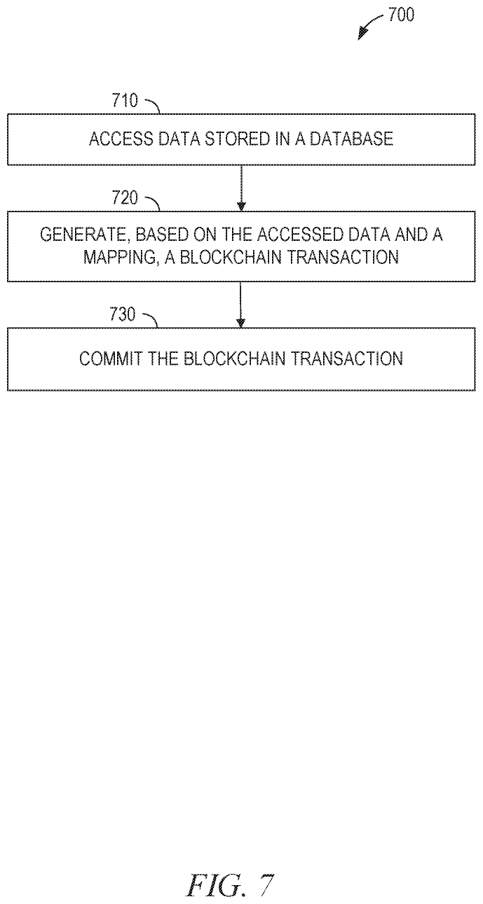

FIG. 7 is a flowchart illustrating operations of a method 700 suitable for storing data in a blockchain using a blockchain integration layer, according to some example embodiments. The method 700 includes operations 710, 720, and 730. By way of example and not limitation, the method 700 is described as being performed by the devices, modules, and databases of FIGS. 1-3.

In operation 710, the database module 230 accesses data stored in a database. For example, a row from the docTxt table 335 with a hash value of NULL may be accessed. The NULL value for the hash indicates that the data for the row is not yet stored in the blockchain.

In operation 720, the blockchain adapter module 240 generates a blockchain transaction based on the accessed data and a mapping. For example, the mapping described above in FIG. 3 with respect to the docTxt message type may be used. In this example, the type of the message may be identified from the type field and the keys are identified from the properties fields. Thus, with reference to the row 345C of the docTxt table 335 in FIG. 3, a transaction including a message of type docTxt with ID “GHI” and text “Magna Carta” may be added to the blockchain.

In operation 730, the blockchain adapter module 240 commits the blockchain transaction. The database may be updated to reflect the committing of the transaction. For example, the hash column of the row 345C may be updated to store the hash of the block containing the committed transaction. In this way, a future scan of the docTxt table 335 will distinguish between data to be committed and data already stored in the blockchain on the basis of the presence or absence of a hash value in the hash column. Alternatively or additionally, an additional Boolean column may be added to the docTxt table 335 that indicates whether or not the data is stored in the blockchain, a timestamp column may be added to the docTxt table 335 that indicates when the data was added to the blockchain, or any suitable combination thereof.

FIG. 8 is a flowchart illustrating operations of a method 800 suitable for accessing data in multiple blockchains using a blockchain integration layer, according to some example embodiments. The method 800 includes operations 810, 820, 830, and 840. By way of example and not limitation, the method 800 is described as being performed by the devices, modules, and databases of FIGS. 1-3.

The blockchain adapter module 240 accesses, in operation 810, first data stored in a first blockchain. In operation 820, the blockchain adapter module 240, based on the first data and a first mapping corresponding to the first blockchain, stores third data in a first database table. For example, the first data may be a “docTxt” message accessed from the blockchain server 120A of FIG. 1. Based on the first data and the mapping for “docTxt” messages discussed above with respect to FIG. 3, third data (e.g., data extracted from the message) is stored in the docTxt table 335 of FIG. 3.

The blockchain adapter module 240 accesses, in operation 830, second data stored in a second blockchain. In operation 840, the blockchain adapter module 240, based on the second data and a second mapping corresponding to the second blockchain, stores fourth data in a second database table. For example, the second data may be an “inhabitant” message accessed from the blockchain server 120B of FIG. 1. Based on the second data and the mapping for “inhabitant” messages discussed above with respect to FIG. 3, fourth data data extracted from the message) is stored in the inhabitant table 350 of FIG. 3.

FIG. 9 is a user interface diagram of a user interface 900 suitable for presenting data in multiple blockchains using a blockchain integration layer, according to some example embodiments. The user interface 900 includes a title 910 and data 920. The data 920 includes the row 930, operable to receive data from a user.

The title 910 indicates that the data being displayed is “docTxt” data corresponding to the docTxt table 335 of FIG. 3. The data 920 includes column headers and data for the rows 345A and 345B of the docTxt table 335. For the purposes of this example, the user interface 900 is shown prior to the creation of the row 345C of the docTxt table 335. The row 930 contains user-provided data for a new “docTxt” message to be created in a blockchain. In response to an indication that the user entry is complete (e.g., detection of a press of the Enter key by the user or detection of interaction with another user interface element), the user interface module 220 of the database server 110 provides the received data to the database module 230 for storage in the docTxt table 335. Thus, the row 345C is created. After the creation of the row 345C, the blockchain adapter module 240 determines that the hash of the row is NULL and writes a new “docTxt” message into the corresponding blockchain.

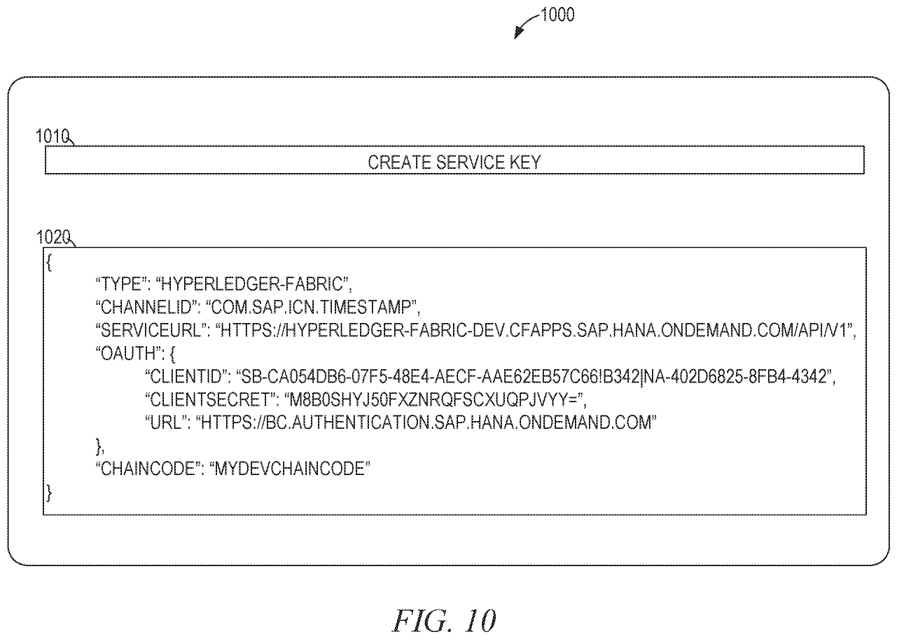

FIG. 10 is a user interface diagram of a user interface 1000 suitable for creating a blockchain service key for use by a blockchain integration layer, according to some example embodiments. The user interface 1000 includes a title 1010 and a text area 1020. The title 1010 indicates that the user interface 1000 is for creation of a service key. The text area 1020 presents a predetermined service key definition, accepts user input for a service key definition, or both.

In the example of FIG. 10, the service key definition is for a Hyperledger Fabric blockchain accessible from the identified Service URL using the provided OAuth credentials. Data will be retrieved from and stored to the identified channel of the blockchain. Additionally, the identified chaincode will be run against the identified channel of the blockchain,

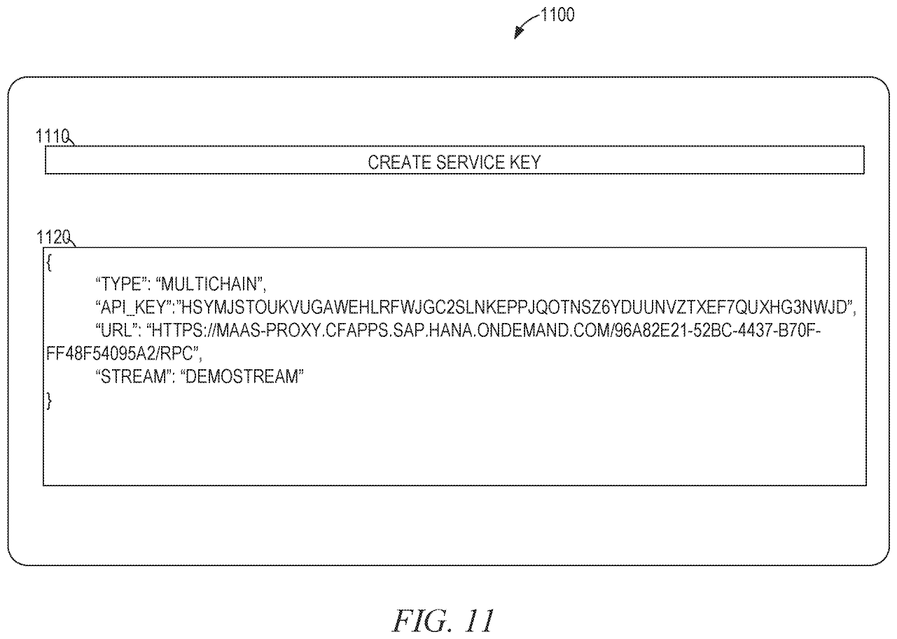

FIG. 11 is a user interface diagram of a user interface 1100 suitable for creating a blockchain service key for use by a blockchain integration layer, according to some example embodiments. The user interface 1100 includes a title 1110 and a text area 1120. The title 1110 indicates that the user interface 1100 is for creation of a service key. The text area 1120 presents a predetermined service key definition, accepts user input for a service key definition, or both.

In the example of FIG. 11, the service key definition is for a MultiChain blockchain accessible from the identified URL using the provided API key. Data will be retrieved from and stored to the identified stream of the blockchain.

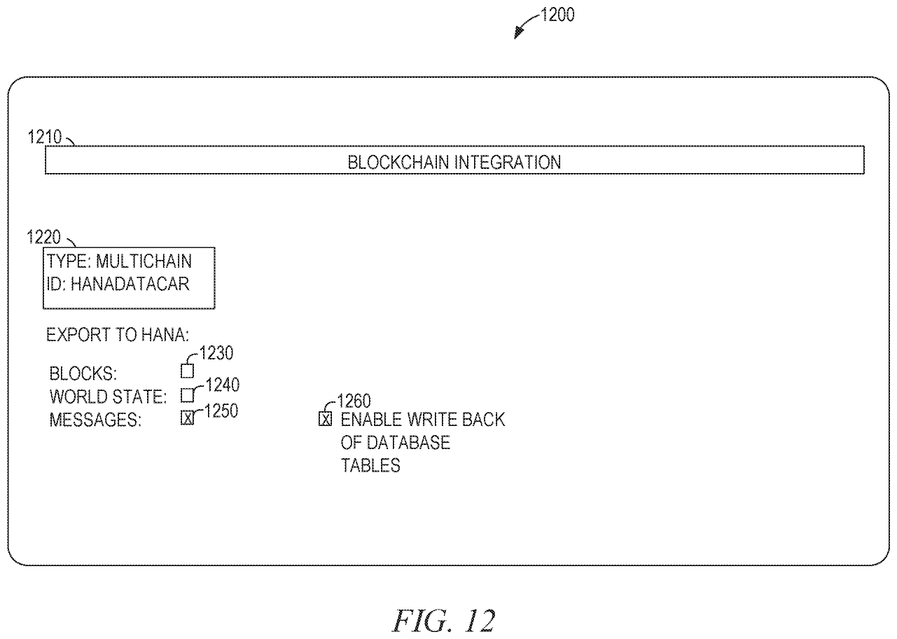

FIG. 12 is a user interface diagram of a user interface 1200 suitable for controlling blockchain integration by a blockchain integration layer, according to some example embodiments. The user interface 1200 includes a title 1210, an informational area 1220, and checkboxes 1230, 1240, 1250, and 1260. The title 1210 indicates that the user interface 1200 is to control blockchain integration. The informational area 1220 indicates the type and identifier of the blockchain for which integration is being controlled.

The checkbox 1230 is operable to control whether blocks from the blockchain are exported to a database. If blocks are exported to the database, header, payload, and transaction tables are populated with data from the blockchain. The header table stores, for each block, a number of the block, a hash of the block, and a hash of the previous block. The payload table stores, for each transaction, a transaction identifier, a transaction timestamp, a namespace, a key, a value, and a delete indicator. The transaction table may be implemented as the transaction table 305, described above with respect to FIG. 3.

The check-box 1240 is operable to control whether world state from the blockchain is stored in a database. If the world state is stored in the database, one or more existing tables in the database are modified to add blockNumber, transactionID, and transactionTimestamp columns. The transactionID column stores the identifier of a transaction corresponding to the row, the transactionTimestamp column stores the timestamp of the identified transaction, and the blockNumber column stores the number of the block storing the transaction.

The world state of a blockchain reflects the current values associated with keys in the blockchain. By way of example, consider transactions T1, T2, and T3 stored somewhere over any number of blocks in a blockchain, where each of the three transactions updates exactly the same key K with a different payload P1, P2, P3. After transaction T1, we have K->P1, after transaction T2, we have K1-22 P2, and so on. This means that the payload associated with key K, depends on which transaction has already been committed to the blockchain. Thus, after T1 has been executed and before T2 has been executed, the world state reflects a value of PI for K. If we read later from the world state after transaction T2 has executed, then K->P2, and so on. This means, that at any moment in time, the world state reflects the current payload that is associated with the key K.

Whether messages from the blockchain are exported to a database is controlled by operation of the checkbox 1250. If messages are exported to the database, one or more existing tables in the database are modified to add the blockNumber, transactionID, and transactionTimestamp columns as well as an isDeleted column. Values for the blockNumber, transactionID, and transactionTimestamp columns are taken from the JSON payload for each transaction. The isDeleted column indicates if the data in the row has been deleted from the blockchain. In some example embodiments, additional columns are added: an identifier column containing the identifier of the message, a text column containing the text of the message, or both.

The checkbox 1260 is operable to control whether data in the database tables are written back to the blockchain. Thus, when this option is enabled, modification of data in the database results in transactions being written to the blockchain e.g., using the method 700 of FIG. 7).

### EXAMPLES

Example 1. A method comprising:
receiving, by a server from a first blockchain server via a network, first data for a first blockchain transaction of a first blockchain;
receiving, by the server from a second blockchain server via the network, second data for a second blockchain transaction of a second blockchain;
storing, by the server, based on the first data and a first mapping, third data in a first database table;
storing, by the server, based on the second data and a second mapping, fourth data in a second database table; and
causing a user interface to be presented on a client device, the user interface comprising the third data.

Example 2. The method of example 1, wherein:
the first mapping maps keys of key-value pairs in the first blockchain to columns in the first database table; and
the storing of the third data in the first database table comprises storing, for each mapped key-value pair of the first mapping, a value of the key-value pair in the mapped column of the key of the key-value pair.

Example 3. The method of example 1 or example 2, wherein:
the second mapping maps keys of key-value pairs in the second blockchain to columns in the second database table; and
the storing of the fourth data in the second database table comprises storing, for each mapped key-value pair of the second mapping, a value of the key-value pair in the mapped column of the key of the key-value pair.

Example 4. The method of any of examples 1 to 3, wherein:
the first data comprises a message in the first blockchain, the message having a message type; and
the first database table corresponds to the message type.

Example 5. The method of any of examples 1 to 4, further comprising:
accessing fifth data stored in the first database table; and
based on the fifth data being stored in the first database table, identifying the first blockchain; and
generating, based on the identification of the first blockchain and the first mapping, an entry in the first blockchain.

Example 6. The method of example: 5, wherein:
the accessing of the fifth data comprises accessing a row of the first database table, the row comprising a first value of a first column, the first column being mapped by the first mapping to a first key; and
based on the first mapping and the row of the first database table, the generating of the entry in the first blockchain comprises storing a key-value pair having the first key as the key and the first value as the value.

Example 7. The method of example 5 or example 6, wherein:
the generating of the entry in the first blockchain comprises generating the entry with a message type corresponding to the first database table.

Example 8. A system comprising:
a memory that stores instructions; and
one or more processors configured by the instructions to perform operations comprising:
receiving, from a first blockchain server via a network, first data for a first blockchain transaction of a first blockchain;
receiving, from a second blockchain server via the network, second data for a second blockchain transaction of a second blockchain;
storing, based on the first data and a first mapping, third data in a first database table;
storing based on the second data and a second mapping, fourth data in a second database table; and
causing a user interface to be presented on a client device, the user interface comprising the third data.

Example 9. The system of example 8, wherein:
the first mapping maps keys of key-value pairs in the first blockchain to columns in the first database table: and
the storing of the third data in the first database table comprises storing, for each mapped key-value pair of the first mapping, a value of the key-value pair in the mapped column of the key of the key-value pair.

Example 10. The system of example 9, wherein:
the second mapping maps keys of key-value pairs in the second blockchain to columns in the second database table; and
the storing of the fourth data in the second database table comprises storing, for each mapped key-value pair of the second mapping, a value of the key-value pair in the mapped column of the key of the key-value pair.

Example 11. The system of any of examples 8 to 10, wherein:
the first data comprises a message in the first blockchain, the message having a message type; and
the first database table corresponds to the message type.

Example 12. The system of any of examples 8 to 11, wherein the operations further comprise:
accessing fifth data stored in the first database table; and based on the fifth data being stored in the first database table, identifying the first blockchain; and
generating, based on the identification of the first blockchain and the first mapping, an entry in the first blockchain.

Example 13. The system of example 12, wherein:
the accessing of the fifth data comprises accessing a row of the first database table, the row comprising a first value of a first column, the first column being mapped by the first mapping to a first key; and
based on the first mapping and the row of the first database table, the generating of the entry in the first blockchain comprises storing a key-value pair having the first key as the key and the first value as the value.

Example 14. The system of example 12 or example 13, wherein:
the generating of the entry in the first blockchain comprises generating the entry with a message type corresponding to the first database table.

Example 15. A non-transitory computer-readable medium that stores instructions that, when executed by one or more processors, cause the one or more processors to perform operations comprising:
receiving, from a first blockchain server via a network, first data for a first blockchain transaction of a first blockchain;
receiving, from a second blockchain server via the network, second data for a second blockchain transaction of a second blockchain;
storing, based on the first data and a first mapping, third data in a first database table;
storing, based on the second data and a second mapping, fourth data in a second database table; and
causing a user interface to be presented on a client device, the user interface comprising the third data.

Example 16. The computer-readable medium of example 15, wherein:
the first mapping maps keys of key-value pairs in the first blockchain to columns in the first database table; and
the storing of the third data in the first database table comprises storing, for each mapped key-value pair of the first mapping, a value of the key-value pair in the mapped column of the key of the key-value pair.

Example 17. The computer-readable medium of example 15 or example 16, wherein:
the second mapping maps keys of key-value pairs in the second blockchain to columns in the second database table; and
the storing of the fourth data in the second database table comprises storing, for each mapped key-value pair of the second mapping, a value of the key-value pair in the mapped column of the key of the key-value pair.

Example 18. The computer-readable medium of any of examples 15 to 17, wherein:
the first data comprises a message in the first blockchain, the message having a message type; and
the first database table corresponds to the message type.

Example 19. The computer-readable medium of any of examples 15 to 18, wherein the operations further comprise:
accessing fifth data stored in the first database table; and based on the fifth data being stored in the first database table, identifying the first blockchain; and
generating, based on the identification of the first blockchain and the first mapping, an entry in the first blockchain.

Example 20. The computer-readable medium of any of examples 15 to 19, wherein:
the accessing of the fifth data comprises accessing a row of the first database table, the row comprising a first value of a first column, the first column being mapped by the first mapping to a first key; and
based on the first mapping and the row of the first database table, the generating of the entry in the first blockchain comprises storing a key-value pair having the first key as the key and the first value as the value.

FIG. 13 is a block diagram illustrating components of a machine 1300, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 13 shows a diagrammatic representation of the machine 1300 in the example form of a computer system within which instructions 1324 (e.g., software, a program, an application, an applet, an app, or other executable code) for causing the machine 1300 to perform any one or more of the methodologies discussed herein may be executed, in whole or in part. In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a distributed (e.g., peer-to-peer) network environment. The machine 1300 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1324, sequentially or otherwise, that specify actions to be taken by that machine. Further, while only a single machine is illustrated, the term “machine” shall also be taken to include a collection of machines that individually or jointly execute the instructions 1324 to perform all or part of any one or more of the methodologies discussed herein.

The machine 1300 includes a processor 1302 (e.g., a central processing unit (CPU), a graphics processing unit (GPU), a digital signal processor (DSP), an application-specific integrated circuit (ASIC), a radio-frequency integrated circuit (RHC), or any suitable combination thereof), a main memory 1304, and a static memory 1306, which are configured to communicate with each other via a bus 1308. The machine 1300 may further include a graphics display 1310 (e.g., a plasma display panel (PDP), a light-emitting diode (LED) display, a liquid crystal display (LCD), a projector, or a cathode ray tube (CRT)). The machine 1300 may also include an alphanumeric input device 1312 (e.g., a keyboard), a cursor control device 1314 (e.g., a mouse, a touchpad, a trackball, a joystick, a motion sensor, or another pointing instrument), a storage unit 1316, a signal generation device 1318 (e.g., a speaker), and a network interface device 1320.

The storage unit 1316 includes a machine-readable medium 1322 on which are stored the instructions 1324 embodying any one or more of the methodologies or functions described herein. The instructions 1324 may also reside, completely or at least partially, within the main memory 1304, within the processor 1302 (e.g., within the processor's cache memory), or both, during execution thereof by the machine 1300. Accordingly, the main memory 1304 and the processor 1302 may be considered as machine-readable media. The instructions 1324 may be transmitted or received over a network 1326 via the network interface device 1320.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown, in an example embodiment, to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., the machine 1300), such that the instructions, when executed by one or more processors of the machine (e.g., the processor 1302), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules code embodied on a machine-readable medium or in a transmission signal) or hardware modules. A “hardware module” is a tangible unit capable of performing certain operations and may be configured or arranged in a certain physical manner. In various example embodiments, one or more computer systems g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, by a server from a first blockchain server via a network, first data for a first blockchain transaction of a first blockchain;
receiving, by the server from a second blockchain server via the network, second data for a second blockchain transaction of a second blockchain;
storing, by the server, based on the first data and a first mapping, third data in a first database table:
storing, by the server, based on the second data and a second mapping, fourth data in a second database table; and
causing a user interface to be presented on a client device, the user interface comprising the third data.

2. The method of claim 1, wherein:
the first mapping maps keys of key-value pairs in the first blockchain to columns in the first database table; and
the storing of the third data in the first database table comprises storing, for each mapped key-value pair of the first mapping, a value of the key-value pair in the mapped column of the key of the key-value pair.

3. The method of claim 2, wherein:
the second mapping maps keys of key-value pairs in the second blockchain to columns in the second database table; and
the storing of the fourth data in the second database table comprises storing, for each mapped key-value pair of the second mapping, a value of the key-value pair in the mapped column of the key of the key-value pair.

4. The method of claim 1, wherein:
the first data comprises a message in the first blockchain, the message having a message type; and
the first database table corresponds to the message type.

5. The method of claim 1, further comprising:
accessing fifth data stored in the first database table;
based on the fifth data being stored in the first database table, identifying the first blockchain; and
generating, based on the identification of the first blockchain and the first mapping, an entry in the first blockchain.

6. The method of claim 5, wherein:
the accessing of the fifth data comprises accessing a row of the first database table, the row comprising a first value of a first column, the first column being mapped by the first mapping to a first key; and
based on the first mapping and the row of the first database table, the generating of the entry in the first blockchain comprises storing a key-value pair having the first key as the key and the first value as the value.

7. The method of claim 5, wherein:
the generating of the entry in the first blockchain comprises generating the entry with a message type corresponding to the first database table.

8. A system comprising:
a memory that stores instructions; and
one or more processors configured by the instructions to perform operations comprising:
receiving, from a first blockchain server via a network, first data for a first blockchain transaction of a first blockchain;
receiving, from a second blockchain server via the network, second data for a second blockchain transaction of a second blockchain;
storing, based on the first data and a first mapping, third data in a first database table;
storing, based on the second data and a second mapping, fourth data in a second database table; and
causing a user interface to be presented on a client device, the user interface comprising the third data.

9. The system of claim 8, wherein:
the first mapping maps keys of key-value pairs in the first blockchain to columns in the first database table; and
the storing of the third data in the first database table comprises storing, for each mapped key-value pair of the first mapping, a value of the key-value pair in the mapped column of the key of the key-value pair.

10. The system of claim 9, wherein:
the second mapping maps keys of key-value pairs in the second blockchain to columns in the second database table; and
the storing of the fourth data in the second database table comprises storing, for each mapped key-value pair of the second mapping, a value of the key-value pair in the mapped column of the key of the key-value pair.

11. The system of claim 8, wherein:
the first data comprises a message in the first blockchain, the message having a message type; and
the first database table corresponds to the message type.

12. The system of claim 8, wherein the operations further comprise:
accessing fifth data stored in the first database table; and
based on the fifth data being stored in the first database table, identifying the first blockchain; and
generating, based on the identification of the first blockchain and the first mapping, an entry in the first blockchain.

13. The system of claim 12, wherein:
the accessing of the fifth data comprises accessing a row of the first database table, the row comprising a first value of a first column, the first column being mapped by the first mapping to a first key; and
based on the first mapping and the row of the first database table, the generating of the entry in the first blockchain comprises storing a key-value pair having the first key as the key and the first value as the value.

14. The system of claim 12, wherein:
the generating of the entry in the first blockchain comprises generating the entry with a message type corresponding to the first database table.

15. A non-transitory computer-readable medium that stores instructions that, when executed by one or more processors, cause the one or more processors to perform operations comprising:
receiving, from a first blockchain server via a network, first data for a first blockchain transaction of a first blockchain;
receiving, from a second blockchain server via the network, second data for a second blockchain transaction of a second blockchain;
storing, based on the first data and a first mapping, third data in a first database table;
storing, based on the second data and a second mapping, fourth data in a second database table; and
causing a user interface to be presented on a client device, the user interface comprising the third data.

16. The computer-readable medium of claim 15, wherein:
the first mapping maps keys of key-value pairs in the first blockchain to columns in the first database table; and
the storing of the third data in the first database table comprises storing, for each mapped key-value pair of the first mapping, a value of the key-value pair in the mapped column of the key of the key-value pair.

17. The computer-readable medium of claim 16, wherein:
the second mapping maps keys of key-value pairs in the second blockchain to columns in the second database table; and
the storing of the fourth data in the second database table comprises storing, for each mapped key-value pair of the second mapping, a value of the key-value pair in the mapped column of the key of the key-value pair.

18. The computer-readable medium of claim 15, wherein:
the first data comprises a message in the first blockchain, the message having a message type; and
the first database table corresponds to the message type.

19. The computer-readable medium of claim 15, wherein the operations further comprise:
accessing fifth data stored in the first database table; and
based on the fifth data being stored in the first database table, identifying the first blockchain; and
generating, based on the identification of the first blockchain and the first mapping, an entry in the first blockchain.

20. The computer-readable medium of claim 19, wherein:
the accessing of the fifth data comprises accessing a row of the first database table, the row comprising a first value of a first column, the first column being mapped by the first mapping to a first key; and
based on the first mapping and the row of the first database table, the generating of the entry in the first blockchain comprises storing a key-value pair having the first key as the key and the first value as the value.
